(19) United States
(12) Patent Application Publication
(10) Pub. No.: US 2025/0237793 A1
(43) Pub. Date: Jul. 24, 2025

(54) COATED MICROSTRUCTURED FILMS AND METHODS OF MAKING SAME

(71) Applicant: 3M INNOVATIVE PROPERTIES COMPANY, St. Paul, MN (US)

(72) Inventors: Daniel J. Schmidt, Woodbury, MN (US); Brylee David Tiu, Miieapolis, MN (US); Caleb T. Nelson, McKinney, TX (US); Kevin W. Gotrik, Hudson, WI (US)

(21) Appl. No.: 18/700,744

(22) PCT Filed: Oct. 31, 2022
(86) PCT No.: PCT/IB2022/060488

§ 371 Date: Apr. 12, 2024

Related U.S. Application Data
(60) Provisional application No. 63/287,718, filed on Dec. 9, 2021.

(51) Int. Cl. G02B 3/08

(52) U.S. Cl. CPC G02B 3/08

(57) ABSTRACT

The present disclosure provides a coated microstructured film. The coated microstructured film includes microstructures extending across a first surface of the microstructured film and a coating disposed on a first portion of at least some of the microstructures. The coating includes a polymer that is the reaction product of a composition comprising at least one of a phenol or a polyphenol. A second portion lacks some or all of the coating. A method of making the coated microstructured film is also provided. The method includes obtaining a microstructured film, applying a coating containing one or more polyelectrolytes to at least some of the microstructures, and removing at least a portion of the coating from a second portion of the coated microstructures to provide the coating disposed on a first portion of the coated microstructures.

### BACKGROUND

Various microstructured films are known, having engineered microstructured shapes. Further developments in films/articles including microstructured surfaces would be desirable.

### SUMMARY

In a first aspect, a coated microstructured film is provided. The coated microstructured film includes a) a plurality of microstructures extending across a first surface of the microstructured film; and b) a coating disposed on a first portion of at least some of the microstructures. The coating includes a polymer that is the reaction product of a composition comprising at least one of a phenol or a polyphenol. A second portion lacks some or all of the coating.

In a second aspect, a method of making a coated microstructured film is provided. The method includes: obtaining a microstructured film comprising a plurality of microstructures extending across a first surface of the microstructured film; applying a coating of a composition comprising at least one of a phenol or a polyphenol to at least some of the microstructures across the first surface of the microstructured film; and removing at least a portion of the coating from a second portion of the microstructures to provide the coating disposed on a first portion of the coated microstructures.

Beyond typically providing a brown-colored coating, a coating formed from a composition containing a phenol and/or a polyphenol, according to at least certain embodiments of the present disclosure may advantageously provide a platform for subsequent reactions and surface functionalization. For instance, catechol groups are reducing agents which can reduce metal salts to zero-valent metals uniformly or in a patterned manner. Silver can be reduced without exogenous reducing agents, whereas copper requires supplemental reducing agents. Precious metal catalysts are not required to support such electroless metallization. Additionally, catechols can also react with thiols and amines via Michael addition or Schiff base reactions to create organic ad-layers.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1A is a flow chart of exemplary methods according to the present disclosure.

FIG. 1B is a cross-sectional schematic illustration of an exemplary method of making a coated microstructured film and a light control film.

FIG. 2A is a schematic perspective view of a microstructured film having a plurality of ribs alternating with channels.

FIG. 2B is a schematic cross-sectional view of a microstructured film having a plurality of ribs alternating with channels.

FIG. 3A is a schematic cross-sectional view of a microstructured film having a plurality of facets and sidewalls each meeting at a ridge of the microstructure.

FIG. 3B is a schematic cross-sectional view of a microstructured film that is a linear prism.

FIG. 3C is a schematic cross-sectional view of a microstructured film that is a linear Fresnel element.

FIG. 4A is a schematic cross-sectional view of a microstructured film that has a two-dimensional array of projections.

FIG. 4B is a top plan view of four representative engineered micropatterned regions for a two-dimensional array of projections.

FIG. 5A is a schematic cross-sectional view of a microstructured film having a plurality of cavities extending between two major surfaces.

FIG. 5B is generalized schematic exploded view of a microstructured film having a plurality of cavities extending between two major surfaces.

FIG. 6A is a scanning electron microscopy (SEM) image of a portion of a microstructure having a coating of polydopamine on side wall and top surfaces, preparable according to the present disclosure.

FIG. 6B is an SEM image of a portion of a microstructure after application of a coating of polydopamine and removal of at least some of the coating from the top surface, preparable according to the present disclosure.

FIG. 6C is an SEM image of a portion of a microstructure after application of a coating of polydopamine, removal of at least some of the coating from the top surface, and deposition of silver on the side wall surface, preparable according to the present disclosure.

FIG. 6D is an SEM image of a portion of the side wall surface of a microstructure according to FIG. 6C, at a higher magnification.

FIG. 7 is an SEM image of a portion of a microstructure after application of a coating of polydopamine and deposition of silver on the coating, preparable according to the present disclosure.

While the above-identified figures set forth various embodiments of the disclosure, other embodiments are also contemplated, as noted in the description. In all cases, this disclosure presents the invention by way of representation and not limitation. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

### Glossary

As used herein, “microstructures” refer to engineered elements having at least two feature dimensions that are microscopic, namely 1 micrometer to less than 1000 micrometers.

As used herein, “engineered” with respect to microstructures refers to surface features that were created from a specific design with deterministic position, size, shape, spacing, and dimensions.

As used herein, the term “essentially free” in the context of a composition being essentially free of a component, refers to a composition containing less than 1% by weight (wt. %), 0.5 wt. % or less, 0.25 wt. %, 0.1 wt. %, 0.05 wt. %, 0.001 wt. %, or 0.0001 wt. % or less of the component, based on the total weight of the composition; or less than 1% by volume (vol. %), 0.5 vol. % or less, 0.25 vol. %, 0.1 vol. %, 0.05 vol. %, 0.001 vol. %, or 0.0001 vol. % or less of the component, based on the total volume of the composition. The term “essentially free” in the context of a feature of a structure (e.g., a surface of a layer), refers to a structure having less than 5% by area of the component, 4% or less, 3%, 2%, or 1% or less by area of the component, based on the total area of the structure.

As used herein, “facet” refers to a flat, convex, or concave surface.

The term “phenol” refers to a compound having a hydroxyl group linked directly to a benzene ring. The term “polyphenol” refers to a compound including more than one phenolic hydroxyl group.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, a coated microstructured film is provided. The coated microstructured film comprises:
a) a plurality of microstructures extending across a first surface of the microstructured film; and
b) a coating disposed on a first portion of at least some of the microstructures, the coating comprising a polymer that is the reaction product of a composition comprising at least one of a phenol or a polyphenol, and wherein a second portion lacks some or all of the coating.

In a second aspect, a method of making a coated microstructured film is provided. The method comprises:
obtaining a microstructured film comprising a plurality of microstructures extending across a first surface of the microstructured film;
applying a coating of a composition comprising at least one of a phenol or a polyphenol to at least some of the microstructures across the first surface of the microstructured film; and
removing at least a portion of the coating from a second portion of the microstructures to provide the coating disposed on a first portion of the coated microstructures.

The first and second aspects are described in detail below.

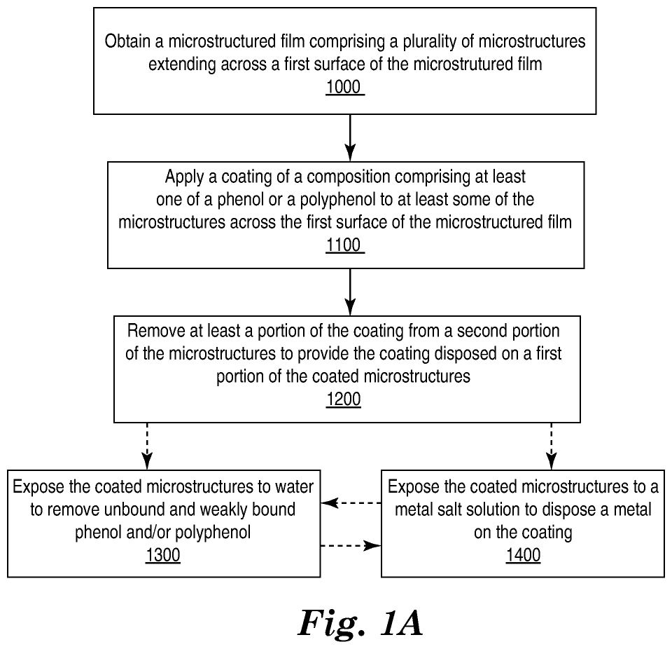

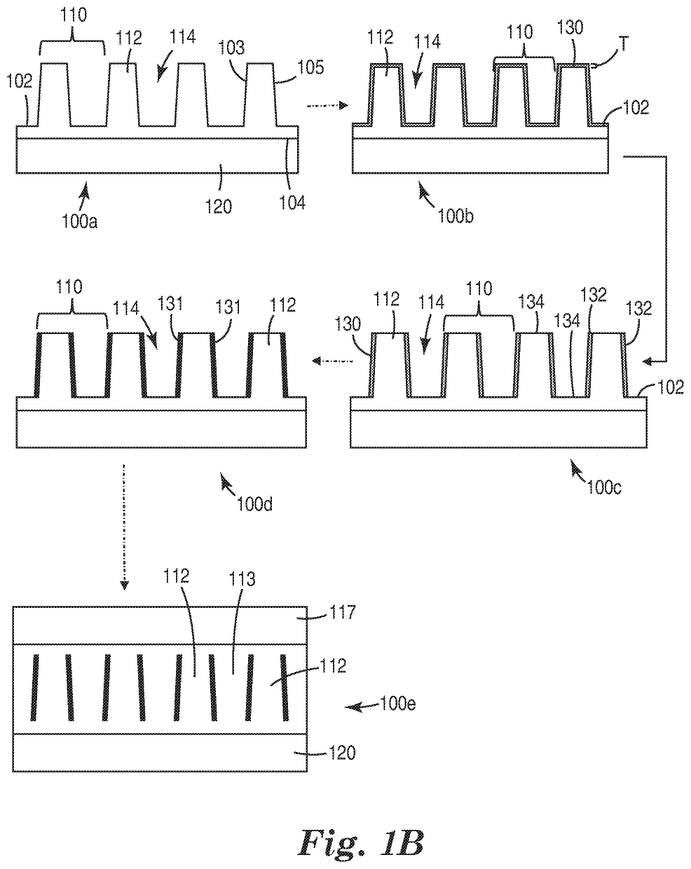

Referring to FIG. 1A, methods according to the present disclosure include Step 1000 to obtain a microstructured film comprising a plurality of microstructures extending across a first surface of the microstructured film and Step 1100 to apply a coating of a composition comprising at least one of a phenol or a polyphenol to at least some of the microstructures across the first surface of the microstructured film. Step 1200 is further included, to remove at least a portion of the coating from a second portion of the microstructures to provide the coating disposed on a first portion of the coated microstructures.

Referring to FIG. 1B, a cross-sectional schematic illustration is provided of an exemplary method of making a coated microstructured film. More particularly, to start, FIG. 1B shows a microstructured film 100a having a plurality of microstructures 110 extending across a first (e.g., major) surface 102 of the microstructured film 100a. In this particular embodiment, the microstructures 110 comprise a plurality of ribs 112 alternated with channels 114. Each rib 112 includes side walls 103 and 105. Optionally, a substrate 120 is adjacent to a second (e.g., major) surface 104 of the microstructured film 100a. Next, FIG. 1B shows a microstructured film 100b comprising a coating 130 that has been applied to the microstructures 110 across the first surface 102 of the microstructured film 100b.

In any embodiment according to the present disclosure, the first surface of the microstructured film is optionally subjected to surface treatment prior to applying the coating. Suitable surface treatments include, for example and without limitation, corona treatment, plasma treatment, flame treatment, and/or a deposited oxide layer (e.g., to provide an etch stop in addition to improving wetting of the surface).

The coating (e.g., layer) on the first portion of microstructures comprises a polymer that is the reaction product of a composition comprising at least one of a phenol or a polyphenol, typically an oxidative polymerization of the phenol and/or polyphenol. Phenols and polyphenols have been employed to form adherent coatings on substrates due to structural similarities to the types of adhesive proteins found in mussels (e.g., lysine amino acid and 3,4-dihydroxy-L-phenylalanine (DOPA)). In many cases, the composition comprises a polyphenol. One type of polyphenol is a catecholamine. In certain embodiments, a suitable catecholamine comprises a catechol compound containing an amino group, such as dopamine. Other types of catecholamines may also be used, including but not limited to, dopamine, norepinephrine, polydopamine, 3,4-dihydroxy-L-phenylalanine (DOPA), 3,4-dihydroxyphenylalanine methyl ester, epinephrine, or any combination thereof. Additional exemplary polyphenols include for instance 6-nitrodopamine, 2-bromo-N-[2-(3,4-dihydroxyphenyl)ethyl]-2-methyl propenamide, and 5-hydroxydopamine. Other polymers may be formed from nitrogen-free phenols and polyphenols, examples of which include hydrocaffeic acid, alkylcatechol, thiol-terminated catechols, gallol, pyrogallol, tannic acid, epigallocatechin gallate (EGCG), epicatechin gallate (ECG), and epigallocatechin (EGC). Additional suitable phenols and polyphenols include those described in U.S. Pat. No. 8,541,060 (Messersmith et al.). In select embodiments, suitable compounds include polydopamine, pyrogallol, gallic acid, tannic acid, or combinations thereof.

Typically, the composition is prepared and applied to the microstructured surface as an alkaline aqueous solution having oxidative conditions. The term “aqueous” means that the liquid of the coating contains at least 85 percent by weight of water. It may contain a higher amount of water such as, for example, at least 90, 95, or even at least 99 percent by weight of water or more. The aqueous liquid medium may comprise a mixture of water and one or more water-soluble organic cosolvent(s), in amounts such that the aqueous liquid medium forms a single phase. Examples of water-soluble organic cosolvents include methanol, ethanol, isopropanol, 2-methoxyethanol, 3-methoxypropanol, 1-methoxy-2-propanol, tetrahydrofuran, and ketone or ester solvents. The amount of organic cosolvent typically does not exceed 15 wt. % of the total liquids of the coating composition. The term “alkaline” means exhibiting a pH value of a composition ranging from 7.1 to 12, such as 7.5 to 10 or 7.5 to 8.5. The term “oxidative conditions” refers to a composition having an alkaline pH including an oxidant such as dissolved oxygen or an organic base (e.g., triethylamine). Other suitable oxidants include for instance and without limitation, hydrogen peroxide, sodium periodate, ammonium persulfate, tertiary butylhydroperoxide, organic peroxides, quinones (e.g., benzoquinones, napthoquinones, or anthraquinones), metal oxidants (e.g., Cu²⁺, Fe³⁺, Co³⁺ or Mn³⁺), phenols, indoles, or aminobenzenes.

When a nitrogen-free phenol and/or polyphenol is employed, the composition often also has high ionic strength conditions to assist in successful deposition on a substrate, such as by including a salt in a concentration of between 0.001 millimolar (mM) and 1 mM, e.g., at least 10 mM or at least 50 mM. For instance, suitable salts include a sodium salt, a potassium salt, a calcium salt, a magnesium salt, a copper salt, and/or a zinc salt. Exemplary salts may be mentioned, such as NaCl, NaNO₃, Na₂SO₄, KCl, K₂SO₄, MgCl₂, CaCl₂, CuCl₂, and ZnCl₂. Compositions and methods of deposition including nitrogen-free phenols/polyphenols are described in detail in U.S. Pat. No. 10,179,114 (Messersmith et al.).

The composition usually comprises at least 0.05 wt. % or 0.1 wt. % of phenol and/or polyphenol and typically no greater than 5 wt. %, 4 wt. %, 3 wt. %, 2 wt. % or 1 wt. %.

Typically, the coating process involves exposing the substrate (e.g., microstructured film) to a composition comprising at least one of a phenol or a polyphenol (e.g., an alkaline aqueous solution having oxidative conditions). This can be accomplished by immersion of the substrate into a liquid bath (also referred to as dip coating), spraying, spin coating, roll coating, inkjet printing, and the like. Optionally, the step of applying the coating occurs in a container and the first surface of the microstructured film is oriented normal to a floor of the container. Such an orientation tends to improve uniformity of the coating and/or to minimize adsorption of polymer nanoparticles on the microstructured surfaces.

In order for mass transfer and adsorption to occur, exposure time of the substrate to the composition is typically on the order of minutes to hours, such as 15 minutes or greater, 30 minutes, 45 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, or 18 hours or more; and 30 hours or less, 28 hours, 26 hours, 24 hours, 23 hours, 22 hours, 21 hours, 20 hours, 19 hours, 18 hours, 17 hours, 16 hours, 15 hours, 14 hours, 13 hours, or 12 hours or less.

In some embodiments, at least one of elevated temperature or UV irradiation or agitation is employed to increase the speed of the application of a polymer on the substrate. For instance, the contacting of the composition with the substrate may be performed at a temperature of 25° C. or greater, 27° C., 29° C., 30° C., 32° C., 35° C., 37° C., 40° C., 42° C., 45° C., 47° C., or 50° C. or greater; and 100° C. or less, 90° C., 80° C., 75° C., 70° C., 65° C., 60° C., 55° C., or 50° C. or less. In some embodiments, the contacting of the composition with the substrate may be accompanied by UV irradiation of the substrate (e.g., with wavelength between 200 and 300 nm) to generate reactive oxygen species, as described in Du et al. Adv. Mater. 2014, 26, 8029-8033. In some embodiments of the method, the applying the coating comprises contacting the first surface of the microstructured film with the composition and applying agitation to the composition during the contacting. Agitation of the composition with the substrate may include stirring (e.g., with a magnetic stir bar), sonication, or shaking of the composition. It is noted that sonication is typically not suitable for a composition including dissolved oxygen as the only oxidant because the sonication tends to remove the dissolved oxygen from the composition.

The phenol and/or the polyphenol is preferably polymerized during the contacting of the composition with the surface of the microstructured film to form a polymer.

From a practical perspective, it is possible that not every coating process will result in 100% of the microstructures having a layer of coating disposed on their surfaces. At least 10% of the microstructures comprise the coating, 15% or greater, 20%, 25%, 30%, 35%, 40%, 45%, 50%, 55%, 60%, 65%, 70%, 75%, 80%, 82%, 84%, 86%, 88%, 90%, 92%, 94%, 96% or 98% or greater of the microstructures comprise the coating.

FIG. 1B additionally shows a microstructured film 100c from which a portion of the coating 130 has been removed from a second portion 134 of the microstructures 110 to provide the coating 130 on a first portion 132 of the microstructures 110. As is apparent from the illustration, each of the first portion 132 of the microstructures 110 and the second portion 134 of the microstructures is a discontinuous portion. Typically, individual regions of the first portion of microstructures and of the second portion of microstructures will alternate with each other over the first surface of the microstructured film (e.g., a first portion including rib sidewalls and a second portion including rib tops and channel bottom surfaces). The presence of coating on the side walls could be determined by looking at the side walls using angular x-ray photoelectron spectroscopy (XPS). In alternate embodiments, the second portion includes only some (e.g., horizontal) surfaces, for example, just the rib tops but not the channel bottom surfaces.

In general, the coating is either significantly thinner or substantially not present on certain surfaces (i.e., the second portion) of the microstructures than others (i.e., the first portion). A thickness of the coating is typically less than 1 micrometer, such as 900 nm or less, 800 nm, 700 nm, 600 nm, 500 nm, 400 nm, 300 nm, 200 nm, or 100 nm or less; and 1 nm or greater, 5 nm or greater, or 10 nm or greater. Thickness can be determined, for instance, by using scanning electron microscopy (SEM) or transmission electron microscopy (TEM) of a cross-section of the microstructured film.

It is to be understood that following coating and removal of areas/thicknesses of the coating, the resulting coated microstructured film is likely to have minor variabilities in the coverage of the first portion of the microstructured surface depending on the precision of the coating and selective removal processes. Accordingly, it is possible that less than 100% of the surfaces of the first portion of the microstructured film may be covered, e.g., at least 10% of the surfaces of the first portion of the microstructured film are covered, 15% or greater, 20%, 25%, 30%, 35%, 40%, 45%, 50%, 55%, 60%, 65%, 70%, 75%, 80%, 82%, 84%, 86%, 88%, 90%, 92%, 94%, 96% or 98% or greater of the surfaces of the first portion of the microstructured film are covered.

Any suitable method can be used to selectively remove the coating (e.g., layer) from the second portion of the microstructures. In one embodiment, the coating is removed by reactive ion etching. Reactic ion etching (RIE) is a directional etching process utilizing ion bombardment to remove material. RIE systems are used to remove organic or inorganic material by etching surfaces orthogonal to the direction of the ion bombardment. The most notable difference between reactive ion etching and isotropic plasma etching is the etch direction. Reactive ion etching is characterized by a ratio of the vertical etch rate to the lateral etch rate which is greater than 1. Systems for reactive ion etching are built around a durable vacuum chamber. Before beginning the etching process, the chamber is evacuated to a base pressure lower than 1 Torr, 100 mTorr, 20 mTorr, 10 mTorr, or 1 mTorr. An electrode holds the materials to be treated and is electrically isolated from the vacuum chamber. The electrode may be a rotatable electrode in a cylindrical shape. A counter electrode is also provided within the chamber and may be comprised of the vacuum reactor walls. Gas comprising an etchant enters the chamber through a control valve. The process pressure is maintained by continuously evacuating chamber gases through a vacuum pump. The type of gas used varies depending on the etch process. Carbon tetrafluoride (CF₄), sulfur hexafluoride (SF₆), octafluoropropane (C₃F₈), fluoroform (CHF₃), boron trichloride (BCl₃) hydrogen bromide (HBr), chlorine, argon, and oxygen are commonly used for etching. RF power is applied to the electrode to generate a plasma Samples can be conveyed on the electrode through plasma for a controlled time period to achieve a specified etch depth. Reactive ion etching is known in the art and further described in U.S. Pat. No. 8,460,568 (David et al.); incorporated herein by reference.

In some embodiments, reactive ion etching may result in the coating being thinner near the bottom surface of a microstructure. Removing the coating can result in a (e.g., slight) increase in the depth of a channel or base layer of the microstructured film.

From a practical perspective, it is possible that not every removal process will result in removing some or all of the coating from the second portion of 100% of the microstructures having a layer of coating disposed on their surfaces. Accordingly, in some cases 5% or more of the microstructures have none of the coating removed from their second portion, such as 7% or more, 9%, 10%, 12%, 15% or more; and 20% or less of the microstructures have none of the coating removed from their second portion.

Referring again to FIG. 1A, in any method of making a coated microstructured film, Step 1300 may optionally include to expose the coated microstructures to water to remove unbound and weakly bound phenol and/or polyphenol. Such a washing/rinsing step can typically also remove particles of any of the composition components that may be adsorbed to the coating.

In some cases, the method further comprises Step 1400 to expose the coated microstructures to a metal salt solution to dispose a metal on the coating. Preferably, the metal is disposed on the second portion of at least some of the microstructures. In some cases, the metal is present as a continuous layer whereas in other cases the metal is present as a discontinuous layer. Presence of a metal on the coated microstructured film may be determined using transmission electron microscopy (TEM) with energy-dispersive X-ray spectroscopy (EDS). As mentioned above, an advantage of coatings of at least certain embodiments of the present disclosure is that they can reduce metal salts to zero-valent metals. Exemplary metals that can be disposed on the coating include for instance and without limitation, silver, nickel, gold, copper, cobalt, chromium, zinc, tin, iron, platinum, palladium, ruthenium, rhodium, iridium, osmium or combinations thereof. In select embodiments, the metal is silver. Typical conditions for depositing a metal includes exposure of the coating to a composition containing a metal salt in a concentration of 10 to 500 mM metal, having pH of 3 to 8, and a temperature of 20° C. to 70° C.

FIG. 1B additionally shows a microstructured film 100d which may be a light control film. The microstructured film 100d includes a light absorbing material in and/or on the coating 130 that is located on side walls 131 of the microstructures 110.

### Microstructured Films

### Louver Structure

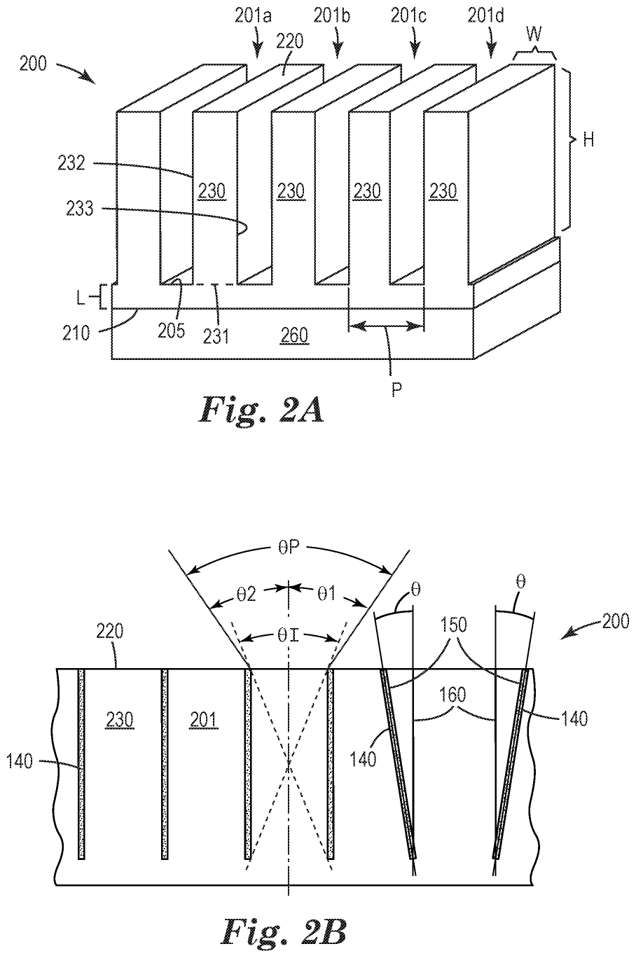

FIG. 2A shows an embodied microstructured film 200 having a louver structure, which can be coated to make a coated microstructured film according to the present disclosure. The depicted microstructured film 200 includes a microstructured surface 210 comprising a plurality of channels 201a-201d on base layer 260. As shown in FIG. 2A, a continuous land layer “L” can be present between the bottom of the channels 205 and the top surface 210 to base layer 260. Alternatively, the channels 201 can extend all the way through the microstructured film article 200. In some cases (not shown), the bottom surface 205 of the groove can be coincident with the top surface 210 of a base layer 260. In typical embodiments, the base layer 260 is a preformed film that comprises a different organic polymeric material than the ribs 230.

The height and width of ribs (e.g., protrusions) 230 are defined by adjacent channels (e.g., 201a and 201b). The ribs 230 can be defined by atop surface 220, a bottom surface, 231, and side walls 232 and 233 that join the top surface to the bottom surface. The side walls can be parallel to each other. More typically the side walls have a wall angle.

The ribs 230 can be defined by a width “W”. Often, the ribs have a width parallel to the first surface of the microstructured film and a height orthogonal to the first surface of the microstructured film. Excluding the land region “L”, the ribs 230 typically have nominally the same height as the channels 201. In typical embodiments, the height “H” of the channels 201 and/or the ribs 230 is at least 10, 20, 30, 40, 50, 60, 70, 80, 90 or 100 micrometers. In some embodiments, the height is no greater than 250, 240, 230, 220, 210, 200, 190, 180, 170, 160, 150, 140, 130, 120, 110, or 100 micrometers. In some embodiments, the height of the channels 201 and/or the ribs 230 ranges from 50 to 250 micrometers. The microstructured film typically comprises a plurality of ribs 230 having nominally the same height and width. In some embodiments, the ribs 230 have a height, “H”, a maximum width at its widest portion, “W”, and an aspect ratio, H/W, of at least 1.5. In some embodiments, H/W is at least 1.75, 2.0, 2.25, 2.5, 2.75, 3.0, 3.5, 4.0, 4.5 or 5.0. In other embodiments, the aspect ratio of the ribs is at least 6, 7, 8, 9, or 10. In other embodiments, the aspect ratio of the ribs is at least 15, 20, 25, 30, 35, 40, 45, or 50.

Channels 201 have a height “H” defined by the distance between the bottom surface 205 and top surface 220, such top and bottom surfaces typically being parallel to the top surface 210 of a base layer 260. The channels 201 have a maximum width “W” and are spaced apart along microstructured surface 210 by a pitch “P”. The width of the channels “W”, at the base (i.e., adjacent to bottom surface 205) is typically nominally the same as the width of the channels adjacent the top surface 220. However, when the width of the channels at the base differs from the width adjacent the top surface, the width is defined by the maximum width. The maximum width of a plurality of channels can be averaged for an area of interest, such as an area in which visible light transmission is measured. The microstructured film typically comprises a plurality of channels having nominally the same height and width. In typical embodiments, the channels generally have a width no greater than 50, 40, 30, 20, 10, 9, 8, 7, 6, 5, 4, 3, 2, or 1 micrometer. In some embodiments, the channels generally have a width no greater than 900, 800, 700, 600, or 500 nanometers. In some embodiments, the channels have a width of at least 50, 60, 70, 80, 90, or 100 nanometers.

As shown in FIG. 2B, a microstructured film 200 includes alternating ribs 230 and filled channels 201, with coatings 140 on the ribs 230, and an interface 150 between coatings 140 and filled channels 201. Interface 150 forms a wall angle θ with line 160 that is perpendicular to first surface 220 of the microstructured film 200. Larger wall angles θ decrease light transmission (following application of a coating) at normal incidence or in other words a viewing angle of 0 degrees. Smaller wall angles are preferred such that the transmission of light at normal incidence can be made as large as possible. In some embodiments, the wall angle θ is less than 10, 9, 8, 7, 6, 5, 4, 3, 2, 1, or 0.1 degrees. In some embodiments, the wall angle is no greater than 2.5, 2.0. 1.5, 1.0, 0.5, or 0.1 degrees. In some embodiments, the wall angle is zero or approaching zero. When the wall angle is zero, the angle between the channels and first surface 220 is 90 degrees. Depending on the wall angle, the ribs can have a rectangular or trapezoidal cross-section. In some embodiments, the side walls can be described as comprising first and second side walls, in which the first side wall has a wall angle with a line that is perpendicular to the first surface of the microstructured film from 0 degrees to +10 degrees or from 0 degrees to −10 degrees relative to the bottom surface of the microstructured film.

In some embodiments, the ribs 230 have a pitch, “P” of at least 10 micrometers. The pitch is the distance between the onset of a first rib and the onset of a second rib as depicted in FIG. 2A. The pitch may be at least 15, 20, 25, 30, 35, 40, 45, 50, 60, or 70 micrometers. The pitch is generally no greater than 1 mm. The pitch is typically no greater than 900, 800, 700, 600, or 500 micrometers. In some embodiments, the pitch is typically no greater than 550, 500, 450, 400, 350, 300, 250 or 200 micrometers. In some embodiments, the pitch is no greater than 175, 150, 100 micrometers. In typical embodiments, the ribs are evenly spaced, having a single pitch. Alternatively, the ribs may be spaced such that the pitch between adjacent ribs is not the same. In this later embodiment, at least some and typically the majority (at least 50, 60, 70, 80, 90% or greater of the total ribs) have the pitch just described. The pitch of the channels is within the same range as just described for the ribs. Optionally, the channels have an average pitch of 10 to 200 micrometers. The pitch and height of the ribs can be important to facilitate coating of the ribs with a coating. When the ribs are spaced too close together it can be difficult to uniformly coat the side walls. When the ribs are spaced too far apart, the coating may not be effective at providing its intended functions.

A louver structure can be prepared by any suitable method. In one embodiment, a structure, e.g., the microstructured film 200 shown in FIG. 2A, can be prepared by a method including the steps of (a) preparing a polymerizable composition; (b) depositing the polymerizable composition onto a master negative microstructured molding surface (e.g., tool) in an amount barely sufficient to fill the cavities of the master; (c) filling the cavities by moving a bead of the polymerizable composition between a (e.g., preformed film) base layer and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions and has a surface energy that allows clean removal of the polymerized material from the master. When the base layer is a preformed film, one or more of the surfaces of the film can optionally be primed or otherwise be treated to promote adhesion to the organic material of the microstructure.

The polymerizable resin can comprise a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition can comprise a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

The polymerizable resin can be a radiation curable polymeric resin, such as a UV curable resin. In some cases, polymerizable resin compositions useful for the microstructured film of the present disclosure can include polymerizable resin compositions such as are described in U.S. Pat. No. 8,012,567 (Gaides et al.).

The chemical composition and thickness of the base layer can depend on the end use of the microstructured film. In typical embodiments, the thickness of the base layer can be at least about 0.025 millimeters (mm) and can be from about 0.05 mm to about 0.25 mm. Useful base layer materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefin-based material such as cast or orientated films of polyethylene, polypropylene, and polycyclo-olefins, polyimides, and glass. Optionally, the base layer can contain mixtures or combinations of these materials. In some embodiments, the base layer may be multi-layered or may contain a dispersed component suspended or dispersed in a continuous phase.

Examples of base layer materials include polyethylene terephthalate (PET) and polycarbonate (PC). Examples of useful PET films include photograde polyethylene terephthalate, available from DuPont Films (Wilmington, DE) under the trade designation “Melinex 618”. Examples of optical grade polycarbonate films include LEXAN polycarbonate film 8010, available from GE Polymershapes, Seattle, WA, and Panlite 1151, available from Teijin Kasei, Alpharetta, GA.

Alternatively, the microstructured film 200 can be prepared by melt extrusion, i.e., casting a fluid resin composition onto a master negative microstructured molding surface (e.g., tool) and allowing the composition to harden. In this embodiment, the ribs 230 are interconnected in a continuous layer to base layer 260. The individual ribs and connections therebetween generally comprise the same thermoplastic material. The thickness of the land layer (i.e., the thickness excluding that portion resulting from the replicated microstructure) is typically between 0.001 and 0.100 inches and preferably between 0.003 and 0.010 inches. Suitable resin compositions for melt extrusion are transparent materials that are dimensionally stable, durable, weatherable, and readily formable into the desired configuration. Examples of suitable materials include acrylics, which have an index of refraction of about 1.5, such as Plexiglas brand resin manufactured by Rohm and Haas Company (Philadelphia, PA); polycarbonates, which have an index of refraction of about 1.59; reactive materials such as thermoset acrylates and epoxy acrylates; polyethylene based ionomers, such as those marketed under the brand name of SURLYN by Dow Chemical (Midland, MI); (poly)ethylene-co-acrylic acid; polyesters; polyurethanes; and cellulose acetate butyrates. Polycarbonates are particularly suitable because of their toughness and relatively higher refractive index.

In yet another embodiment, the master negative microstructured molding surface (e.g., tool) can be employed as an embossing tool, such as described in U.S. Pat. No. 4,601,861 (Pricone).

Further details regarding microstructured films having such louver structures and how to form them are described in WO 2019/118685 (Schmidt et al.) and WO 2020/026139 (Schmidt et al.), each incorporated herein by reference.

### Facet Structure

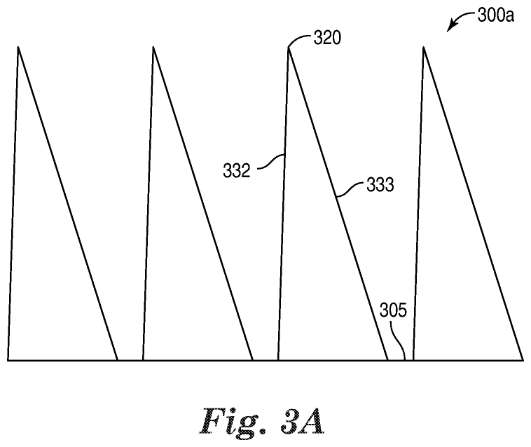

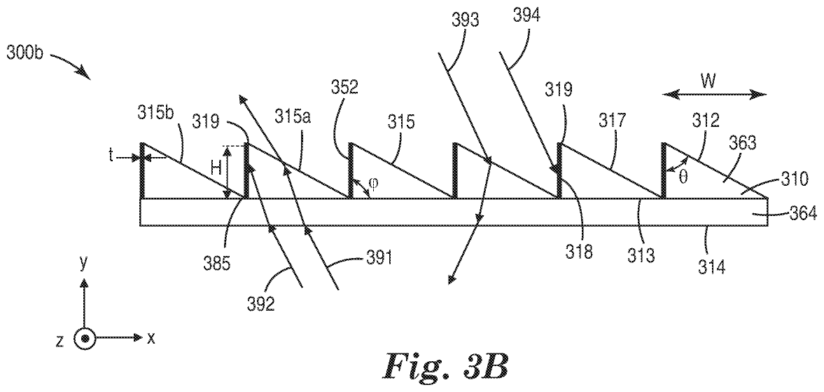

FIG. 3A shows an embodied microstructured film 300a having a facet structure, which can be coated to make a coated microstructured film according to the present disclosure. More particularly, FIG. 3A illustrates a microstructured film 300a defining bottom surfaces 305, top surfaces 320, first sidewalls 332 and facets 333. Stated another way, the microstructures comprise a facet 333 and a side wall 332 meeting the facet 333 at a ridge 320 of the microstructure. The facet 333 and the side wall 332 typically define an oblique angle therebetween. When such a facet structure is used in a coated microstructured film, the first portion on which the coating (not shown) is disposed comprises the side wall 332 and the second portion comprises the facet 333 and the bottom surface 305. In any embodiment of microstructured films according to the present disclosure, the facet 33 may have a convex or concave surface instead of a flat surface as shown in FIG. 3A. Further details regarding microstructured films having such facet structures and how to form them are described in WO 2020/250180 (Kenney et al.), incorporated herein by reference.

In some microstructured films including a facet structure, each of the microstructures is a linear prism having a substantially same angle between the optical facet and the side wall, or a linear Fresnel element.

Referring to FIG. 3B, a schematic cross-sectional view is provided of a microstructured film 300b comprising a linear prism. The microstructured film 300b can include opposing first 312 and second 314 major surfaces where the first major surface 312 includes a plurality of microstructures 315. The microstructures 315 have a width W that is typically less than 1 mm. The width W and/or the height H can be the same for different microstructures. In this embodiment, the plurality of microstructures 315 includes a plurality of linear prisms for redirecting light where each prism has a substantially same geometry (e.g., the angle θ can be a same angle for each prism).

Each microstructure 315 includes a facet 317 and a sidewall 318 meeting the facet 317 at a ridge 319 of the microstructure. The facet 317 and the sidewall 318 define an oblique angle θ therebetween. In some embodiments, the oblique angle θ is at least 20 degrees or at least 30 degrees and is no more than 80 degrees or no more than 70 degrees. When such a linear prism facet structure is used in a coated microstructured film, the first portion on which the coating 352 is disposed comprises the sidewall 318 and the second portion comprises the facet 317. The microstructured film 300b may also have a polymeric layer 310, which may include a polymeric structured layer 363 formed on a substrate layer 364 (e.g., a polymeric substrate).

Referring to FIG. 3C, a schematic cross-sectional view is provided of a microstructured film 300c comprising a Fresnel element. Microstructured film 300c comprises a polymeric layer 310 and a plurality of microstructures 340. Each microstructure 340 includes a facet 342 and a sidewall 344 meeting the facet 342 at a ridge 346 of the microstructure 340. The facet 342 and the side wall 344 typically define an oblique angle therebetween. Unlike the linear prism microstructures shown in FIG. 3B, however, the Fresnel element includes microstructures 340 that have a varying geometry (e.g., the angle can vary from a center of the microstructured film 300c to an edge of the microstructured film 300c), typically selected to produce a desired optical effect. Further, the width and/or the height can be different for different microstructures. When such a Fresnel element facet structure is used in a coated microstructured film, the first portion on which the coating (not shown) is disposed comprises the side wall 344 and the second portion comprises the facet 342.

Further details regarding microstructured films having such linear prism and Fresnel element structures and how to form them are described in WO 2021/090130 (Liu et al.) and US 2012/0204566 (Hartzell et al.), each incorporated herein by reference.

### Projection Array Structure

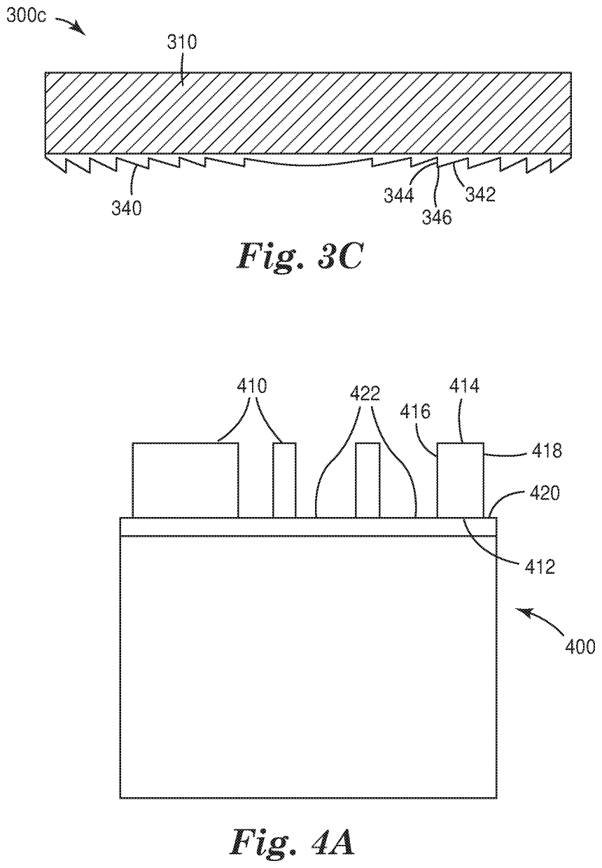

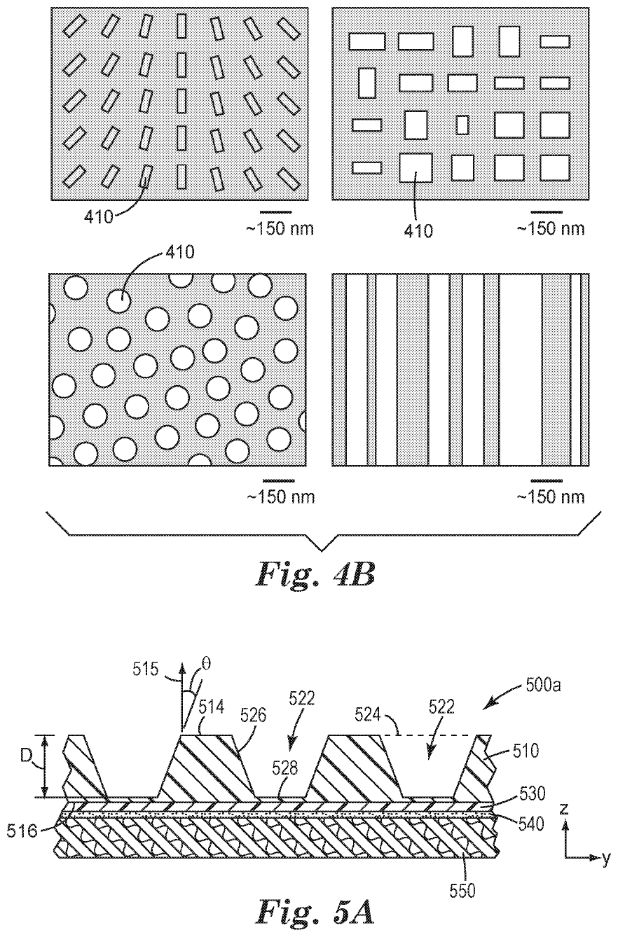

FIG. 4A shows an embodied microstructured film 400 having a projection array structure, which can be coated to make a coated microstructured film according to the present disclosure. More particularly, FIG. 4A is a schematic cross-sectional view of a microstructured film 400 that has a two-dimensional (x- and y-axes) array of projections 410 arranged across a first surface 420. Each of the projections 410 comprises a base 412, a top 414, and one or more sides 416, 418 connecting the top to the base. Optionally, each of the projections 410 is a spaced-apart post. For instance, FIG. 4B is a top plan view of four representative engineered micropatterned regions for a two-dimensional array of projections, including spaced-apart posts 410 present in all but the lower right image. Some microstructured surfaces may comprise projections with a range of aspect ratio values, such as an array of projections with constant height and variable width. In such cases, the surface is usually characterized by the largest aspect ratio value.

When such a projection array structure is used in a coated microstructured film, the first portion on which the coating (not shown) is disposed comprises the sides 416 and 418 and the second portion comprises the top 414. Further, when the each of the projections 410 is a spaced-apart post, the second portion also comprises a surface 422 of the microstructured film 400 between the spaced-apart posts (i.e., projections 410).

Further details regarding microstructured films having such projection arrays and how to form them are described in WO 2020/097319 (Wolk et al.), incorporated herein by reference.

### Cavity Array Structure

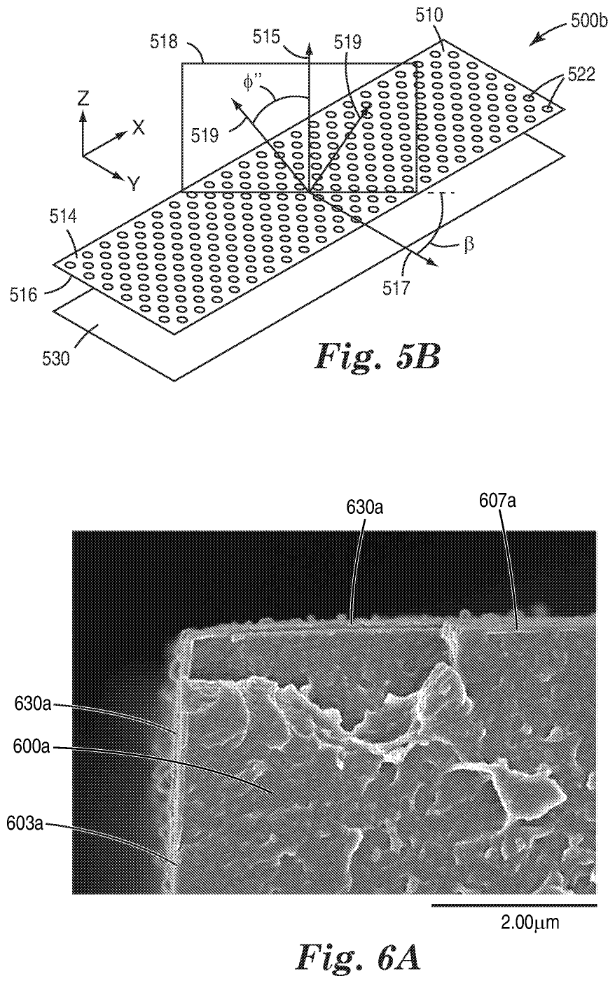

FIG. 5A shows an embodied microstructured film 500a having a cavity array structure, which can be coated to make a coated microstructured film 500a according to the present disclosure. A “cavity array” is an array of cavities having a density of discrete cavities of at least about 100/cm², and preferably at least about 10/mm². The cavities have a three-dimensional structure with dimensions, such as openings with, e.g., diameters in the range of between about 5-250 micrometers, and depths in the range between about 2-250 micrometers. The array can be any regular array such as a close-packed array or a rectangular array, or the cavities can be randomly distributed. More particularly, FIG. 5A is a schematic cross-sectional view of a microstructured film 500a having a plurality of cavities 522 extending between a first major surface 514 and a second major surface 516. The microstructured film 500a comprises a microstructured layer 510 with first 514 and second 516 major surfaces, in which the microstructures comprise a plurality of cavities 522 extending between the first 514 and second 516 major surfaces. Each cavity comprises a first opening 524, a second opening 528 and at least one side wall 526 extending between the first opening 524 and the second opening 528. Each of the side wall(s) 526 forms a side wall angle θ with a line 515 perpendicular to the first major surface 514 of the microstructured layer 510. Each of the cavities 522 further includes a depth “D” which is the perpendicular distance between first opening 524 and second opening 528. Optionally, the microstructured film 500a further includes any of an adhesive layer 540, a first substrate 530, or a second substrate layer 550.

When such a cavity array structure is used in a coated microstructured film, the first portion on which the coating (not shown) is disposed comprises the at least one side wall 526 and the second portion comprises at least one of the first major surface 514 or the second opening 528 of the microstructured layer 510.

FIG. 5B is generalized schematic top perspective exploded view of a microstructured film 500b having a plurality of cavities 522 extending between two major surfaces. The microstructured film 500b includes a microstructured layer 510 with a first major surface 514 and an opposing second major surface 516. The first major surface 514 includes an array of discrete cavities 522. In one particular embodiment, each of the cavities 522 includes a cross-section parallel to the first major surface 514 that can be circular shaped, oval shaped, or polygon shaped. The cross-section optionally decreases in size in the direction from the first major surface 514 to the second major surface 516. This embodiment of a microstructured film 500b further includes a (e.g., flexible) substrate 530 coupled to the second major surface 516 of the microstructured layer 510.

Further details regarding microstructured films having such cavity arrays and how to form them are described in U.S. Pat. No. 9,329,311 (Halverson et al.), incorporated herein by reference.

The coated microstructured film tends to exhibit a transmission of visible light of 75% or greater at a viewing angle of 0 degrees, in which the viewing angle is measured relative a line perpendicular (i.e., normal) to the first surface of the microstructured film, due to the lack of coating on the second portion of the microstructures (e.g., at least some surfaces perpendicular to the viewing angle). In some cases, the coated microstructured film exhibits a transmission of visible light of 75% or greater, 76%, 77%, 78%, 79%, 80%, 81%, 82%, 83%, 84%, 85%, 86% 87%, 88%, 89%, 90%, 91%, 92%, 93%, 94%, 95%, 96%, 97%, 98%, or even 99% or greater at a viewing angle of 0 degrees. Visible light transmission (% T) at a viewing angle of 0 degrees can be measured with a BYK (Geretsried, Germany) Haze-gard i instrument. Having a visible light transmission of greater than 100% is possible due to reflections from microstructures that can redirect high angle light from the diffuse light source to the detector.

In some embodiments, the polymer of the coating is light absorbing (e.g., due to having a brown color) and/or a metal deposited on the coated microstructured film is light absorbing. In such embodiments, the coated microstructured film can be considered a light control film. For instance, referring again to FIG. 1B, in some cases, the microstructures 110 of a light control film 100d comprise a plurality of ribs 112 alternated with channels 114 extending across the first surface 102 of the microstructured film, and the method further comprises filling the channels 114 with an organic polymeric material 113 by disposing the organic polymeric material 113 on the coated microstructures 110. In some embodiments, the organic polymeric material is a polymerizable resin composition and the method further comprises (e.g., radiation) curing the polymerizable resin. Often, the same polymerizable resin used in the manufacture of the microstructured film is utilized for filling the channels. Alternatively, a different organic polymeric material (e.g., polymerizable resin composition) is used. When a different organic polymer material (e.g., polymerizable resin composition) is used, the composition is typically selected to be index matched to the ribs. By “index matched”, it is meant that the difference in refractive index between the filling material and ribs is typically less than 0.1 or 0.005. Alternatively, the channels may be filled with a different organic polymeric material (e.g., polymerizable resin composition) having a difference in refractive index of greater than 0.1. In yet another embodiment, the channels are not filled with an organic polymeric material (e.g., polymerized resin). In this embodiment, the channels typically comprise air, having a refractive index of 1.0.

When the channels are filled with a cured polymerizable resin, the light control film 100e may optionally include cover film 117 bonded to the microstructured film with adhesive. Suitable adhesives include any optically clear adhesive, such as a UV-curable acrylate adhesive, a transfer adhesive, and the like. In yet another embodiment, a topcoat may be included rather than a cover film.

Light control films may further comprise other coatings typically provided on the exposed surface. Various hardcoats, antiglare coatings, antireflective coatings, antistatic, and anti-soiling coatings are known in the art. See for example U.S. Pat. Nos. 7,267,850; 7,173,778, PCT Publication Nos. WO2006/102383, WO2006/025992, WO2006/025956 and U.S. Pat. No. 7,575,847.

When the channels are filled with air, the adhesive film and cover film are typically included. When the channels are filled with air, the relative transmission (e.g., brightness) at higher viewing angles can be lower, and thus the film can exhibit improved privacy or more intense color with angle

The resulting article 100e shown in FIG. 1B is a high aspect ratio louver film capable of angular- and, optionally, wavelength-selective light control.

The light control films described herein are particularly useful as a component of a display device as a so-called hybrid privacy filter. The hybrid privacy filter may be used in conjunction with a display surface, wherein light enters the hybrid privacy filter on the input side of the light control film and exits the hybrid privacy filter or film stack at a color shifting film (e.g., a multilayer film that imparts a color shifting effect such as described in U.S. Pat. No. 8,503,122. Suitable color shifting films are described in U.S. Pat. No. 6,531,230 to Weber et al). A great number of electronic devices with displays may be used in conjunction with the present invention including laptop monitors, external computer monitors, cell phone displays, televisions, smart phones, automotive center information displays, automotive driver information displays, automotive side mirror displays (also referred to as e-mirrors), consoles, or any other similar LCD, OLED, micro-LED, or mini-LED based display. An additional benefit to applying hybrid privacy filters to a display is for contrast enhancement.

In further embodiments, the light control films described herein can be useful as coverings for glass. For instance, the light control films may be laminated onto or within fenestrations. The fenestrations may be selected from a glass panel, a window, a door, a wall, and a skylight unit. These fenestrations may be located on the outside of a building or on the interior. They may also be car windows, train windows, airplane passenger windows, or the like. Advantages of incorporating these film stacks into fenestrations include reduced IR transmission (which may lead to increased energy savings), ambient light blocking, privacy, and decorative effects.

In further embodiments, the light control films described herein can be useful for branding on consumer products such as consumer electronics or apparel. For example, a company logo could appear at an oblique viewing angle.

In further embodiments, the light control films described herein can be used in a part of an optical communication system with a sensor, for instance a photoplesmography or other optical sensor applied to a watch. A light control film may be attached to a wearable wrist watch or any wearable device, e.g., attached to a surface of the optical sensor interface on the wearable device. The light absorptive material of the light control film may be spectrally selective in at least a part of light (UV, VIS, NIR, SWIR) range from the light source, for example, an LED or laser source. Such light control films could also include a second light absorptive material in or on an exterior layer (e.g., a top coat or cover film) that is spectrally selective in at least a part of at least one of the mentioned light ranges from the LED. When the light control film is in use, noise sources such as unwanted light from the perspective of the sensor are absorbed through the second material regardless of the incidence angle of the light from light source, such as sunlight or the LED. The second material transmits a range of visible from the LED but the transmission of the light through the entire light control film varies as a function of the incidence angle of the light because the (first) light absorptive material may block or decrease the sunlight or ambient visible light from other light sources that are incident with relatively high incidence angle to (e.g., a wrist of the person wearing) the device so that the light control film may improve signal to noise ratio.

Referring again to FIG. 2B, when the coated microstructured film is a light control film, the light control film includes alternating transmissive regions (i.e., ribs) 230 and absorptive regions (i.e., light absorptive material in and/or on the coating) 140, and an interface 150 between transmissive regions 230 and absorptive regions 140. Interface 150 forms a wall angle θ with line 160 that is perpendicular to light output surface 120. The transmission (e.g., brightness of visible light) can be increased when incident light undergoes total internal reflection (TIR) from the interface between the absorptive and transmissive regions. Whether a light ray will undergo TIR or not, can be determined from the incidence angle with the interface, and the difference in refractive index of the materials of the transmissive and absorptive regions.

Referring again to FIG. 2B, for a light control film having a louver microstructure, transmissive regions 230 between absorptive regions 140 have an interface angle θ_{I} defined by the geometry of alternating transmissive regions 230 and absorptive regions. The interface angle θ_{I} can be defined by the intersection of two lines. The first line extends from a first point, defined by the bottom surface and the side wall surface of a first absorptive region, and a second point, defined by the top surface and side wall surface of the nearest second absorptive region. The second line extends from a first point, defined by the top surface and the side wall surface of the first absorptive region, and a second point, defined by the bottom surface and side wall surface of the second absorptive region. The polar cut-off viewing angle θP is equal to the sum of a polar cut-off viewing half angle θ1 and a polar cut-off viewing half angle θ2 each of which are measured from the normal to a light input surface 202. In typical embodiments, the polar cut-off viewing angle θP is symmetric, and polar cut-off viewing half angle θ1 is equal to polar viewing half angle θ2. Alternatively, the polar cut-off viewing angle θP can be asymmetric, and polar cut-off viewing half angle θ1 is not equal to polar cut-off viewing half angle θ2.

The alternating transmissive (e.g., ribs) and absorptive (e.g., light absorptive material in or on the coating) regions or the total light control film can exhibit increased relative transmission (e.g., brightness) at a viewing angle of 0 degrees. In some embodiments, the relative transmission (e.g., brightness) is at least 75, 80, 85, or 90%. The relative transmission (e.g., brightness) is typically less than 100%. In typical embodiments, the light control film has significantly lower transmission at other viewing angles. For example, in some embodiments, the relative transmission (e.g., brightness) at a viewing angle of −30 degrees, +30 degrees, or an average of −30 degrees and +30 degrees is less than 50, 45, 40, 35, 30, or 25%. In other embodiments, the relative transmission (e.g., brightness) at a viewing angle of 30 degrees, +30 degrees, or the average of −30 degrees and +30 degrees is less than 25, 20, 15, 10 or 5%. In some embodiments, the relative transmission (e.g., brightness) at a viewing angle of +/−35, +/−40, +/−45, +/−50, +/−55, +/−60, +/−65, +/−70, +/−75, or +/−80 degrees is less than 25, 20, 15, 10 or 5%, or less than 5%. In some embodiments, the average relative transmission (e.g., brightness) for viewing angles ranging from +35 to +80 degrees, −35 to −80 degrees, or the average of these ranges is less than 10, 9, 8, 7, 6, 5, 4, 3, or 2%.

Referring again to FIG. 3B, for a light control film having a linear prism microstructure, the coating 352 may be an optically absorptive layer. The optically absorptive layer may be used to block light (e.g., at a wavelength in the range of 400-1500 nm) incident on the sidewall 318 that would otherwise be redirected into an undesired direction. For example, light rays 391 and 392 are incident on the second major surface 314 along a substantially same direction, and light ray 391 is refracted by an optical facet into a desired direction while light ray 392 is blocked from being redirected by a sidewall into an undesired direction. Similarly, light rays 393 and 394 are incident on the first major surface 312 along a substantially same direction, and light ray 393 is refracted by an optical facet into a desired direction while light ray 394 is blocked from being redirected by a sidewall into an undesired direction.

Referring again to FIG. 5B, for a light control film having a cavity array microstructure, a viewing plane 518 is shown to be positioned at an azimuthal angle f from the y-z plane (defined by a perpendicular line 515 parallel to the z-axis and the line 517 parallel to the y-axis). The viewing plane 518 includes the perpendicular line 515 parallel to the z-axis and extends perpendicular to the x-y plane. The viewing plane 518 further includes viewing cutoff lines 519 located at a viewing cutoff angle φ″ measured from the perpendicular line 515, such that for any angle greater than the viewing cutoff angle φ″, light (e.g., at a wavelength in the range of 400-1500 nm) is not substantially transmitted through microstructured film 500b. The magnitude of the viewing cutoff angle φ″ can vary, depending on the azimuthal angle R and the geometry of the cavities 522. In some embodiments, the viewing cutoff angle φ″ can vary from about 10 degrees to about 70 degrees. In some embodiments, the viewing cutoff angle φ″ can remain constant as the azimuthal angle varies from 0 to 360 degrees (for example, when the cavities include a circular cross-section). In some embodiments, the viewing cutoff angle φ″ can vary as the azimuthal angle varies from 0 to 360 degrees.

### Exemplary Embodiments

In a first embodiment, the present disclosure provides a coated microstructured film. The coated microstructured film comprises a) a plurality of microstructures extending across a first surface of the microstructured film; and b) a coating disposed on a first portion of at least some of the microstructures, the coating comprising a polymer that is the reaction product of a composition comprising at least one of a phenol or a polyphenol, and wherein a second portion lacks some or all of the coating.

In a second embodiment, the present disclosure provides a coated microstructured film according to the first embodiment, wherein the composition comprises a polyphenol.

In a third embodiment, the present disclosure provides a coated microstructured film according to the first embodiment or the second embodiment, wherein the composition comprises a nitrogen-free phenol.

In a fourth embodiment, the present disclosure provides a coated microstructured film according to any of the first through third embodiments, wherein the composition comprises polydopamine, pyrogallol, gallic acid, tannic acid, or combinations thereof.

In a fifth embodiment, the present disclosure provides a coated microstructured film according to any of the first through fourth embodiments, further comprising a metal disposed on the polymer.

In a sixth embodiment, the present disclosure provides a coated microstructured film according to the fifth embodiment, wherein the metal is present as a discontinuous layer.

In a seventh embodiment, the present disclosure provides a coated microstructured film according to the fifth embodiment, wherein the metal is present as a continuous layer.

In an eighth embodiment, the present disclosure provides a coated microstructured film according to any of the fifth through seventh embodiments, wherein the metal comprises silver, nickel, gold, copper, cobalt, chromium, zinc, tin, iron, platinum, palladium, ruthenium, rhodium, iridium, osmium or combinations thereof.

In a ninth embodiment, the present disclosure provides a coated microstructured film according to any of the first through eighth embodiments, wherein the microstructures comprise a plurality of ribs alternated with channels extending across the first surface of the microstructured film, wherein each of the ribs comprises side walls and a top surface and each of the channels comprises a bottom surface; and wherein the first portion on which the coating is disposed comprises the side walls of the ribs and the second portion comprises the top surfaces of the ribs and the bottom surfaces of the channels.

In a tenth embodiment, the present disclosure provides a coated microstructured film according to the ninth embodiment, wherein each rib has a width W and a height H and wherein H/W≥1.5.

In an eleventh embodiment, the present disclosure provides a coated microstructured film according to any of the first through tenth embodiments, wherein the ribs have a width parallel to the first surface and a height orthogonal to the first surface.

In a twelfth embodiment, the present disclosure provides a coated microstructured film according to any of the first through eleventh embodiments, wherein the side walls of the ribs have a wall angle less than 5, 4, 3, 2, 1, or 0.1 degrees.

In a thirteenth embodiment, the present disclosure provides a coated microstructured film according to any of the first through twelfth embodiments, wherein the side walls comprise first and second side walls, wherein the first side wall has a wall angle with a line that is perpendicular to the first surface of the microstructured film from 0 degrees to +10 degrees or from 0 degrees to −10 degrees relative to the bottom surface.

In a fourteenth embodiment, the present disclosure provides a coated microstructured film according to any of the first through thirteenth embodiments, wherein the ribs have a height ranging from 50 to 200 micrometers.

In a fifteenth embodiment, the present disclosure provides a coated microstructured film according to any of the first through fourteenth embodiments, wherein the channels have an average pitch of 10 to 200 micrometers.

In a sixteenth embodiment, the present disclosure provides a coated microstructured film according to any of the first through eighth embodiments, wherein the microstructures comprise a facet and a side wall meeting the facet at a ridge of the microstructure and wherein the facet and the side wall define an oblique angle therebetween; and wherein the first portion on which the coating is disposed comprises the side wall and the second portion comprises the facet.

In a seventeenth embodiment, the present disclosure provides a coated microstructured film according to the sixteenth embodiment, wherein each of the microstructures is a) a linear prism having a substantially same angle between the optical facet and the side wall or b) a linear Fresnel element.

In an eighteenth embodiment, the present disclosure provides a coated microstructured film according to any of the first through eighth embodiments, wherein the microstructures comprise a two-dimensional (x- & y-axes) array of projections arranged across the first surface of the microstructured film; wherein each of the projections comprises a base, a top, and one or more sides connecting the top to the base; and wherein the first portion on which the coating is disposed comprises the sides and the second portion comprises the top.

In a nineteenth embodiment, the present disclosure provides a coated microstructured film according to the eighteenth embodiment, wherein each of the projections is a spaced-apart post and the second portion further comprises a surface of the microstructured film between the spaced-apart posts.

In a twentieth embodiment, the present disclosure provides a coated microstructured film according to any of the first through eighth embodiments, wherein the microstructured film comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening; and wherein the first portion on which the coating is disposed comprises the at least one side wall and the second portion comprises at least one of the first major surface or the second major surface of the microstructured layer.

In a twenty-first embodiment, the present disclosure provides a coated microstructured film according to the twentieth embodiment, wherein each of the at least one side walls forms a side wall angle θ with a line perpendicular to the first major surface of the microstructured layer.

In a twenty-second embodiment, the present disclosure provides a coated microstructured film according to any of the first through twenty-first embodiments, wherein the coated microstructured film exhibits a transmission of visible light of 75% or greater at a viewing angle of 0 degrees.

In a twenty-third embodiment, the present disclosure provides a coated microstructured film according to any of the first through twenty-second embodiments, further comprising a metal disposed on the second portion of at least some of the microstructures.

In a twenty-fourth embodiment, the present disclosure provides a coated microstructured film according to any of the first through twenty-third embodiments, further comprising an organic polymeric material disposed on the coated microstructures.

In a twenty-fifth embodiment, the present disclosure provides a method of making a coated microstructured film. The method comprises: obtaining a microstructured film comprising a plurality of microstructures extending across a first surface of the microstructured film; applying a coating of a composition comprising at least one of a phenol or a polyphenol to at least some of the microstructures across the first surface of the microstructured film; and removing at least a portion of the coating from a second portion of the microstructures to provide the coating disposed on a first portion of the coated microstructures.

In a twenty-sixth embodiment, the present disclosure provides a method of making a coated microstructured film according to the twenty-fifth embodiment, further comprising surface treating the first surface of the microstructured film prior to applying the coating.

In a twenty-seventh embodiment, the present disclosure provides a method of making a coated microstructured film according to the twenty-fifth embodiment or the twenty-sixth embodiment, wherein applying the coating comprises contacting the first surface of the microstructured film with the composition and applying agitation to the composition during the contacting.

In a twenty-eighth embodiment, the present disclosure provides a method of making a coated microstructured film according to the twenty-seventh embodiment, wherein the phenol or the polyphenol is polymerized during the contacting of the composition with the first surface of the microstructured film to form a polymer.

In a twenty-ninth embodiment, the present disclosure provides a method of making a coated microstructured film according to any of the twenty-fifth through twenty-eighth embodiments, wherein the composition further comprises an oxidant.

In a thirtieth embodiment, the present disclosure provides a method of making a coated microstructured film according to any of the twenty-fifth through twenty-ninth embodiments, wherein applying the coating occurs in a container and the first surface of the microstructured film is oriented normal to a floor of the container.

In a thirty-first embodiment, the present disclosure provides a method of making a coated microstructured film according to any of the twenty-fifth through thirtieth embodiments, further comprising exposing the coated microstructures to water to remove unbound and weakly bound phenol and/or polyphenol.

In a thirty-second embodiment, the present disclosure provides a method of making a coated microstructured film according to any of the twenty-fifth through thirty-first embodiments, further comprising exposing the coated microstructures to a metal salt solution to dispose a metal on the coating.

In a thirty-third embodiment, the present disclosure provides a method of making a coated microstructured film according to any of the twenty-fifth through thirty-second embodiments, further comprising disposing an organic polymeric material on the coated microstructures.

### EXAMPLES

Unless otherwise noted, all parts, percentages, ratios, etc. in the Examples and the rest of the specification are by weight. Preparative Examples are identified by the label prefix “PE”, Comparative Examples are identified by the label prefix “CE”, and working Examples are identified by the label prefix “EX”.

Unless otherwise indicated, all other reagents were obtained, or are available from fine chemical vendors such as MilliporeSigma, Burlington, Massachusetts, USA, or may be synthesized by known methods. Table 1 (below) lists materials used in the examples and their sources.

TABLE 1

| | | |
|---|---|---|
| DESIGNATION | DESCRIPTION | SOURCE |

RAW MATERIALS FOR RESIN A (SEE PREPARATIVE EXAMPLE 1)

| | | |
|---|---|---|
| Photomer 6010 | Aliphatic urethane diacrylate | BASF Corporation (Florham |
| | Obtained as PHOTOMER 6010 | Park, New Jersey, USA) |
| SR602 | Ethoxylated (10) bisphenol A | Sartomer (Exton, |
| | diacrylate obtained as SR602 | Pennsylvania, USA) |
| SR601 | Ethoxylated (4) bisphenol A | Sartomer |
| | diacrylate Obtained as SR601 | |
| TMPTA | Trimethylolpropane triacrylate | Cytec Industries (Woodland |
| | | Park, New Jersey, USA) |
| PEA (Etermer 2010) | Phenoxyethyl acrylate obtained | Eternal Chemical Co., Ltd., |
| | as ETERMER 2010 | (Kaohsiung, Taiwan) |
| Darocur 1173 | 2-Hydroxy-2- | BASF Corporation |
| | methylpropiophenone | |
| | photoinitiator obtained as | |
| | DAROCUR 1173 | |
| TPO | Diphenyl(2,4,6- | iGM Resins USA (Charlotte, |
| | trimethylbenzoyl)phosphine | North Carolina, USA) |
| | oxide photoinitiator obtained as | |
| | OMNIRAD TPO | |
| I1035 | Anti-oxidant obtained as | BASF Corporation |
| | IRGANOX 1035 | |

RAW MATERIALS FOR POLYPHENOL COATINGS

| | | |
|---|---|---|
| Dopamine hydrochloride | Dopamine hydrochloride | Alfa Aesar (Ward Hill, |
| | | Massachusetts, USA) |
| TA | Tannic acid | Acros Organics (Fair Lawn, |
| | | New Jersey, USA) |
| Bicine | Bicine | Alfa Aesar |
| HCl | Hydrochloric acid (1 Molar) | Avantor Performance |
| | | Materials (Center Valley, |
| | | Pennsylvania, USA) |
| AgNO₃ | Sodium nitrate | Alfa Aesar |

RAW MATERIALS FOR REACTIVE ION ETCHING

| | | |
|---|---|---|
| O₂ | Oxygen (UHP compressed gas) | Oxygen Service Company |
| | | (St. Paul, Minnesota, USA) |

### Test Methods

### Method for Reactive Ion Etching (RIE):

Reactive ion etching was performed in a home-built parallel plate capacitively coupled plasma reactor. The chamber has a central cylindrical powered electrode with a surface area of 18.3 square feet (1.7 square meters). After placing a micro-structured film on the powered electrode, the reactor chamber was pumped down to a base pressure of less than 7 milliTorr (mTorr). O₂ (oxygen) gas was flowed into the chamber at a rate of 1000 standard cubic centimeters per minute (SCCM). Treatment was carried out using a plasma enhanced CVD method by coupling RF power into the reactor at a frequency of 13.56 megahertz (MHz) and an applied power of 7500 watts. Treatment time was controlled by moving the microstructured film through the reaction zone. Following the treatment, the RF power and the gas supply were stopped and the chamber was returned to atmospheric pressure. Additional information regarding materials and processes for applying cylindrical RIE and further details around the reactor used can be found in U.S. Pat. No. 8,460,568 B2.

### Method for Measuring Visible Light Transmission (% T):

Visible light transmission (% T) was measured with a Haze-Gard i (BYK-Gardner USA, Columbia, Maryland, USA).

### Preparative Example PEb 1

A diamond (29.0 micrometers (μm) tip width, 3° included angle, 87 μm deep) was used to cut a copper tool having a plurality of parallel linear grooves. The grooves were spaced apart by a pitch of 62.6 μm.

Resin A was prepared by mixing the materials in Table 2 below with a high speed mixer.

TABLE 2

| Material | Parts by Weight |
|---|---|
| Photomer 6010 | 60.00 |
| SR602 | 20.00 |
| SR601 | 4.00 |
| TMPTA | 8.00 |
| PEA (Etermer 2010) | 8.00 |
| Darocur 1173 | 0.35 |
| TPO | 0.10 |
| I1035 | 0.20 |

A “cast-and-cure” microreplication process was carried out with Resin A and the tool described above. The line conditions were: resin temperature 150° F. (66° C.), die temperature 150° F. (66° C.), coater IR 120° F. (49° C.) edges/130° F. (54° C.) center, tool temperature 100° F. (38° C.), and line speed 70 feet per minute (21.3 meters per minute). Fusion D lamps (Heraeus Holding GmbH, Hanau, Germany), with peak wavelength at 385 nm, were used for curing and operated at 100% power. The resulting microstructured film comprised a plurality of protrusions (e.g., light transmissive regions) separated by channels. The protrusions had a height of 87 micrometers, a width at the top of 29.0 micrometers, and a width at the base of 33.6 micrometers. The channels had a width at the top of 33.6 micrometers, and a width at the base of 29.0 micrometers. Accordingly, a pitch from one protrusion to the next was 62.6 micrometers. The base layer was PET film (3M, St. Paul, MN), having a thickness of 2.93 mils (74.4 micrometers). The side of the PET film that contacts the resin was primed with a thermoset acrylic polymer (Rhoplex 3208 available from Dow Chemical, Midland, MI). The land layer of the cured resin had a thickness of 8 micrometers. The protrusions of the microstructured film are a negative replication of the grooves of the tool. The protrusions have a wall angle of 1.5 degrees resulting in the protrusions being slightly tapered (wider closest to the base film). The channels of the microstructured film are a negative replication of the uncut portions of the tool between the grooves. The % T of the film as measured by a HazeGard i was 94.6%.

### Example EX1

### Polydopamine Coating—One Cycle

In a 1 L plastic beaker, 700 mL of a 0.1 M bicine buffer (pH adjusted to 8.5) was added. A 14-inch long, 9-inch wide (36 centimeters (cm)×23 cm) section of microstructured film from PE-1 was first corona treated by hand using a BD-20AC laboratory corona treater (Electro-Technic Products, Chicago, Illinois, USA) to render the surface water-wettable. Next, it was immersed in a 1 L plastic beaker with the channel direction being horizontal. The beaker was sonicated in a bath sonicator for 1 minute (min) to dislodge any bubbles from the channels. Next, the beaker was stirred with a magnetic stir bar rotating at 300 revolutions per minute (rpm). Dopamine hydrochloride was added to the beaker to a concentration of 2 milligrams/milliliter (mg/mL); it dissolved immediately and began turning the water from clear to brown. After 20 hours, the film was removed and rinsed under a stream of deionized (DI) water. Next, the film was immersed in a 1 L beaker full of DI water and sonicated in a bath sonicator for 3 min to remove weakly bound material. Finally, the film was dried with an air gun. The film had a uniform, light brown color to the naked eye; % T was measured on a Haze-Gard i to be 81.4%. A section of the film was subjected to RIE for 170 sec and the % T was measured to be 92.7%, indicating substantial removal of the polydopamine from the horizontal surfaces of the microstructured film.

### Example EX2

### Polydopamine Coating—Multiple Cycles

In a 1 L plastic beaker, 700 mL of a 0.1 M bicine buffer (pH adjusted to 8.5) was added. A 14-inch long, 9-inch wide (36 cm×23 cm) section of film from PE-1 was first corona treated by hand using a BD-20AC laboratory corona treater (Electro-Technic Products, Chicago, IL, USA) to render the surface water-wettable. Next, it was immersed in a 1 L plastic beaker with the channel direction being horizontal. The beaker was sonicated in a bath sonicator for 1 min to dislodge any bubbles from the channels. Next, the beaker was stirred with a magnetic stir bar rotating at 300 rpm. Ammonium persulfate was added to the beaker to a concentration of 1.2 mg/mL. Next, dopamine hydrochloride was added to the beaker to a concentration of 2 mg/mL; it dissolved immediately and began turning the water from clear to red to brown. After 2.5 hours, the film was removed and rinsed under a stream of DI water. Next, the film was immersed in a 1 L beaker full of DI water and sonicated in a bath sonicator for 3 min to remove weakly bound material. Finally, the film was dried with an air gun. Next, the preceding procedure was repeated three additional times for a total of four cycles of polydopamine deposition. The film had a brown color to the naked eye; % T was measured to be 57.5%. A section of the film was subjected to RIE for 170 sec and the % T was measured to be 93.7%, indicating substantial removal of the polydopamine from the horizontal surfaces of the microstructured film.

### Example EX3

### Polydopamine Coating, RIE, and Silver Metallization

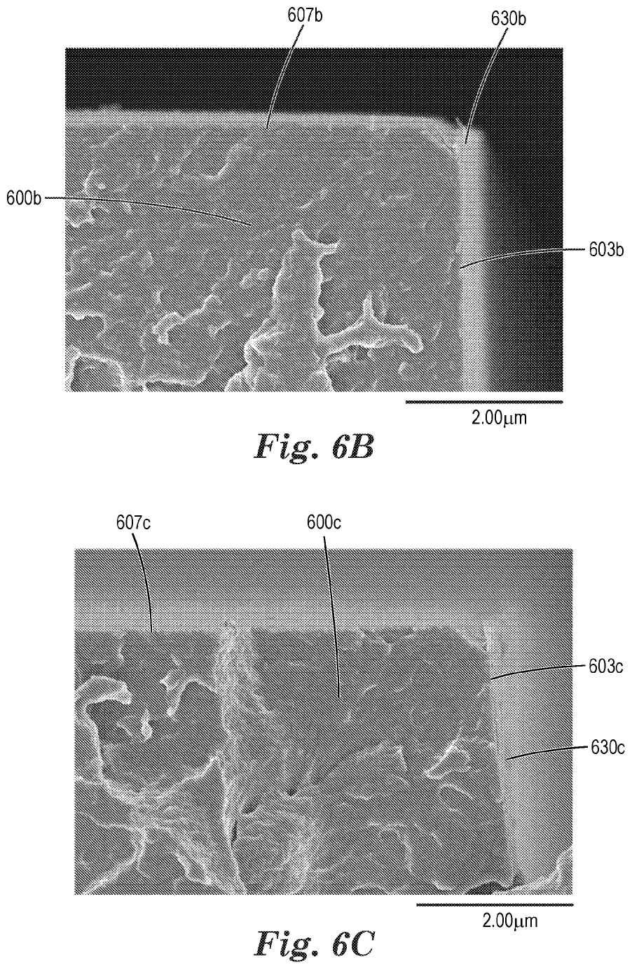

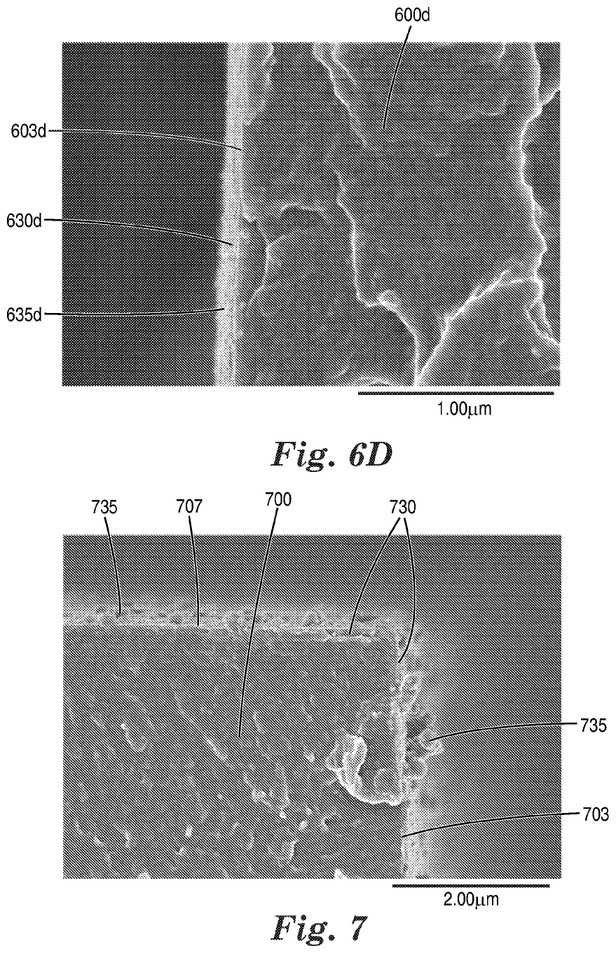

The same procedure from EX1 was followed. FIG. 6A is a scanning electron microscopy (SEM) image, at a 20,000× magnification, of a portion of a microstructure 600a having a coating 630a of polydopamine on a side wall 603a surface and a top surface 607a. FIG. 6B is an SEM image, at a 20,000× magnification, of a portion of a microstructure 600b after both application of a coating 630b of polydopamine and subsequent removal of at least some of the coating from the top surface 607b. The resulting microstructure 630b includes a coating 630b on a side wall 603b.

After the RIE step, the film was immersed in a 50 millimolar (mM) AgNO₃ aqueous solution for 20 hours with gentle stirring at 200 rpm. After rinsing with DI water and drying under a stream of compressed air, the % T was 84.2%. The film appeared relatively clear with a brown tint on-axis and displayed a strong brown/orange color off-axis. The color comes from the plasmonic absorption of silver nanoparticles on the sidewalls.

FIG. 6C is an SEM image, at a 20,000× magnification, of a portion of a microstructure 600c after each of application of a coating 630c of polydopamine, removal of at least some of the coating from the top surface 607c, and deposition of silver (not visible) on the side wall 603c surface. FIG. 6D is an SEM image of a portion of the side wall 603d surface of a microstructure 630d according to FIG. 6C, at a higher magnification (50,000×), where some silver 635d can be seen.

### Comparative Example CE1

### Polydopamine Coating and Silver Metallization (No RIE Step)

The same procedure from EX1 was followed except for the RIE step. A section of the film was immersed in 50 mM AgNO3 for 20 hours with gentle stirring at 200 rpm. After rinsing with DI water and drying under a stream of compressed air, the % T was 57.5% and the film became darker in color, indicating formation of silver nanoparticles on all surfaces.

In contrast to FIG. 6D, FIG. 7 is an SEM image of a portion of a microstructure 700 after application of a coating 730 of polydopamine on a side wall 703 and a top 707 and deposition of silver 735 on the coating 730, but without removing any of the coating 730.

### Example EX4

### Tannic Acid Coating, RIE, and Silver Metallization

In a 1 L plastic beaker, 700 mL of a 0.1 M bicine buffer (pH adjusted to 7.8) was added. Sodium chloride was added to a concentration of 0.6 molar (M). A 14-inch long, 9-inch wide (36 cm×23 cm) section of film from PE-1 was first corona treated by hand using a BD-20AC laboratory corona treater (Electro-Technic Products, Chicago, IL, USA) to render the surface water-wettable. Next, it was immersed in a 1 L plastic beaker with the channel direction being horizontal. The beaker was sonicated in a bath sonicator for 1 min to dislodge any bubbles from the channels. Next, the beaker was stirred with a magnetic stir bar rotating at 300 rpm. Tannic acid was added to the beaker to a concentration of 2 mg/mL; it dissolved over a few minutes and began turning the water from clear to brown. After 20 hours, the film was removed and rinsed under a stream of DI water. Next, the film was immersed in a 1 L beaker full of DI water and sonicated in a bath sonicator for 3 min to remove weakly bound material. Finally, the film was dried with an air gun. The film had a light tan color to the naked eye; % T was measured to be 91.5%. A section of the film was subjected to RIE for 85 sec; the % T was measured to be 92.6% and the film had less color to the naked eye, indicating removal of the polymerized tannic acid from the horizontal surfaces of the microstructured film. The film was then immersed in a 50 mM AgNO₃ aqueous solution for 20 hours with gentle stirring at 200 rpm. After rinsing with DI water and drying under a stream of compressed air, the % T was 81.5%. The film appeared relatively clear on-axis and displayed a brown/orange color off-axis. The color comes from the plasmonic absorption of silver nanoparticles.

A summary of % T data from PE1, EX1 to EX4, and CE1 is shown on Table 3.

TABLE 3

| Example | % T before RIE | % T after RIE | % T after Ag deposition |
|---|---|---|---|
| PE1 | 94.6 | N/A | N/A |
| EX1 | 81.4 | 92.7 | See EX3 |
| EX2 | 57.5 | 93.7 | 90.1 |
| EX3 | 81.4 | 92.7 | 84.2 |
| EX4 | 91.5 | 92.6 | 81.5 |
| CE1 | 81.4 | N/A | 57.5 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A coated microstructured film comprising:
a) a plurality of microstructures extending across a first surface of the microstructured film; and
b) a coating disposed on a first portion of at least some of the microstructures, the coating comprising a polymer that is the reaction product of a composition comprising at least one of a phenol or a polyphenol, and wherein a second portion lacks some or all of the coating.

2. The coated microstructured film of claim 1, wherein the composition comprises polydopamine, pyrogallol, gallic acid, tannic acid, or combinations thereof.

3. The coated microstructured film of claim 1, further comprising a metal disposed on the polymer.

4. The coated microstructured film of claim 3, wherein the metal is present as a discontinuous layer.

5. The coated microstructured film of claim 3, wherein the metal comprises silver, nickel, gold, copper, cobalt, chromium, zinc, tin, iron, platinum, palladium, ruthenium, rhodium, iridium, osmium or combinations thereof.

6. The coated microstructured film of claim 1, wherein the microstructures comprise a plurality of ribs alternated with channels extending across the first surface of the microstructured film, wherein each of the ribs comprises side walls and a top surface and each of the channels comprises a bottom surface; and wherein the first portion on which the coating is disposed comprises the side walls of the ribs and the second portion comprises the top surfaces of the ribs and the bottom surfaces of the channels.

7. The coated microstructured film of claim 6, wherein the ribs have a width parallel to the first surface and a height orthogonal to the first surface.

8. The coated microstructured film of claim 1, wherein the microstructures comprise a facet and a side wall meeting the facet at a ridge of the microstructure and wherein the facet and the side wall define an oblique angle therebetween; and wherein the first portion on which the coating is disposed comprises the side wall and the second portion comprises the facet.

9. The coated microstructured film of claim 8, wherein each of the microstructures is a) a linear prism having a substantially same angle between the optical facet and the side wall or b) a linear Fresnel element.

10. The coated microstructured film of claim 1, wherein the microstructures comprise a two-dimensional (x- & y-axes) array of projections arranged across the first surface of the microstructured film; wherein each of the projections comprises a base, a top, and one or more sides connecting the top to the base; and wherein the first portion on which the coating is disposed comprises the sides and the second portion comprises the top.

11. The coated microstructured film of claim 1, wherein the microstructured film comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening; and wherein the first portion on which the coating is disposed comprises the at least one side wall and the second portion comprises at least one of the first major surface or the second major surface of the microstructured layer.

12. The coated microstructured film of claim 1, wherein the coated microstructured film exhibits a transmission of visible light of 75% or greater at a viewing angle of 0 degrees.

13. The coated microstructured film of claim 1, further comprising a metal disposed on the second portion of at least some of the microstructures.

14. The coated microstructured film of claim 1, further comprising an organic polymeric material disposed on the coated microstructures.

15. A method of making a coated microstructured film, the method comprising:
obtaining a microstructured film comprising a plurality of microstructures extending across a first surface of the microstructured film;
applying a coating of a composition comprising at least one of a phenol or a polyphenol to at least some of the microstructures across the first surface of the microstructured film; and
removing at least a portion of the coating from a second portion of the microstructures to provide the coating disposed on a first portion of the coated microstructures.

16. The method of claim 15, wherein applying the coating comprises contacting the first surface of the microstructured film with the composition and applying agitation to the composition during the contacting, wherein the phenol or the polyphenol is polymerized during the contacting of the composition with the first surface of the microstructured film to form a polymer.

17. The method of claim 15, wherein the composition further comprises an oxidant.

18. The method of claim 15, wherein applying the coating occurs in a container and the first surface of the microstructured film is oriented normal to a floor of the container.

19. The method of claim 15, further comprising exposing the coated microstructures to a metal salt solution to dispose a metal on the coating.
